(19) United States
(12) Patent Application Publication
(10) Pub. No.: US 2021/0257731 A1
(43) Pub. Date: Aug. 19, 2021

(54) SINGLE BEAM STEERING SYSTEM AND MULTI-BEAM STEERING SYSTEM

(71) Applicant: NATIONAL CHIAO TUNG UNIVERSITY, Hsinchu City (TW)

(72) Inventors: Yi-Ting LIN, Taichung City (TW); Zuo-Min TSAI, Miaoli City (TW)

(73) Assignee: NATIONAL CHIAO TUNG UNIVERSITY, Hsinchu City (TW)

(21) Appl. No.: 16/993,842

(22) Filed: Aug. 14, 2020

(30) Foreign Application Priority Data
Feb. 17, 2020 (TW) 109104947

(51) Int. Cl. H01Q 3/34

(52) U.S. Cl. CPC H01Q 3/34

(57) ABSTRACT

A single beam steering system and a multi-beam steering system are provided. The single beam steering system includes a fine-beam tuner and a phased array unit. The fine-beam tuner includes at least one power divider/combiner, a plurality of level controllers and a plurality of switchable inverters. The fine-beam tuner is used to control phase differences between a plurality of phased array signals of the phased array unit. The multi-beam steering system includes an N×N phased array unit, a plurality of M-channel power dividers/combiners and a plurality of the fine-beam tuners mentioned above, wherein the N is an integer greater than 1, and the M is an integer greater than 1. The fine-beam tuners are used to control phase differences between a plurality of phased array signals of the N×N phased array unit.

### CROSS-REFERENCE TO RELATED APPLICATION

This application claims priority from Taiwan Application No. 109104947, filed on Feb. 17, 2020, in the Taiwan Intellectual Property Office, the content of which is hereby incorporated by reference in their entirety for all purposes.

### BACKGROUND

### 1. Technical Field

The invention relates to a beam steering system, especially a single beam steering system and a multi-beam steering system.

### 2. Description of the Related Art

Beamforming technology is an important technology for radar and wireless communication. The commonly adopted technique for beamforming is the phased array technique, which uses tunable phase shifters. In the transmitting state, the phases of signals transmitted to each antenna in the antenna array are controlled, so that the synthetic beam of the phased array is within a certain angle range, and beam steering is performed to transmit signals in different directions. In the receiving state, tunable phase shifters are also used to control the phases of signals received by each antenna in the antenna array, and beam steering is performed to receive signals in different directions.

The conventional phased array above requires complex component structures and control circuits, and the fabrication cost is higher. Therefore, other easy-to-implement techniques are adopted, such as a Butler matrix based beamforming technique. The Butler matrix is an N×N beamforming network (N is an integer greater than 1), usually comprising quadrature hybrid couplers, phase shifters and transmission lines.

The conventional Butler matrix has N output terminals and N input terminals, for example. When an input signal is transmitted to the nth of the input terminals of the Butler matrix (n is an integer greater than 0, n is less than or equal to N), N output signals with a fixed phase difference are generated at the N output terminals of the Butler matrix. When the output signals are individually transmitted to the connected N antennas (antenna array), different antennas emit different electromagnetic waves with phase differences. The different electromagnetic waves are combined into a beam with a fixed direction. Therefore, by switching the input terminals of the Butler matrix, several beams with different directions are switched, and the Butler matrix with N input terminals can generate N beam directions.

Although the conventional Butler matrix described above has a beam switching function, the conventional Butler matrix can only generate a limited number of beams with fixed directions.

### SUMMARY

In order to solve the above problems, an aspect of the invention is to provide a single beam steering system.

To achieve the above aspect, the single beam steering system is applied to an antenna matrix unit comprising a plurality of antenna subunits. The single beam steering system comprises a fine-beam tuner and a phased array unit. The fine-beam tuner comprises at least one power divider/combiner, a plurality of level controllers electrically connected to the at least one power divider/combiner, and a plurality of switchable inverters electrically connected to the level controllers and the phased array unit. The phased array unit is electrically connected to the fine-beam tuner and the antenna subunits, and the phase differences among a plurality of phased array signals of the phased array unit are controlled by the fine-beam tuner.

In order to solve the above problems, another aspect of the invention is to provide a multi-beam steering system.

To achieve an above another aspect, the multi-beam steering system applied to an antenna matrix unit comprising N antenna subunits. The multi-beam steering system comprises a N×N phased array unit, a plurality of M-channel power dividers/combiners and a plurality of fine-beam tuners. The N×N phased array unit is electrically connected to the N antenna subunits, wherein the N is an integer greater than 1. The plurality of M-channel power dividers/combiners are electrically connected to the N×N phased array unit, wherein the M is an integer greater than 1. The plurality of fine-beam tuners are electrically connected to the M-channel power dividers/combiners to control phase differences between a plurality of phased array signals of the N×N phased array unit. Each of the fine-beam tuners is comprises at least one power divider/combiner, a plurality of level controllers electrically connected to the at least one power divider/combiner, and a plurality of switchable inverters electrically connected to the level controllers and the M-channel power dividers/combiners.

Accordingly, based on the phase array, the simple structure, and low cost, continuous beam steering and a beam forming system with multi-beam can be realized.

In order to further understand the technology, means and effects adopted by the invention to achieve the intended purpose, please refer to the following detailed description and accompanying drawings of the invention. It is believed that the purpose, features, and characteristics of the invention can be obtained in-depth and specific understanding, but the drawings are provided for reference and description only, and are not intended to limit the invention.

### BRIEF DESCRIPTION OF THE DRAWINGS

FIG. 1 is a functional block diagram of a single beam steering system according to an embodiment of the invention.

FIG. 2 is a diagram of a beam field pattern simulation and actual measurement results according to an embodiment of the invention (a single beam steering system).

FIG. 3 is a functional block diagram of a multi-beam steering system according to an embodiment of the invention.

FIG. 4 is a diagram of a beam field pattern simulation and actual measurement results according to another embodiment of the invention (a multi-beam steering system).

FIG. 5 is a functional block diagram of a fine-beam tuner according to another embodiment of the invention.

### DETAILED DESCRIPTION

In this disclosure, many specific details are provided so that the specific embodiments of the invention can be thoroughly understood. However, those skilled in the art should know that thet invention can still be practiced without one or more of these specific details. In other cases, well-known details are not shown or described to avoid obscuring the main technical features of the invention. The technical content and detailed description of the invention are described below in conjunction with the drawings:

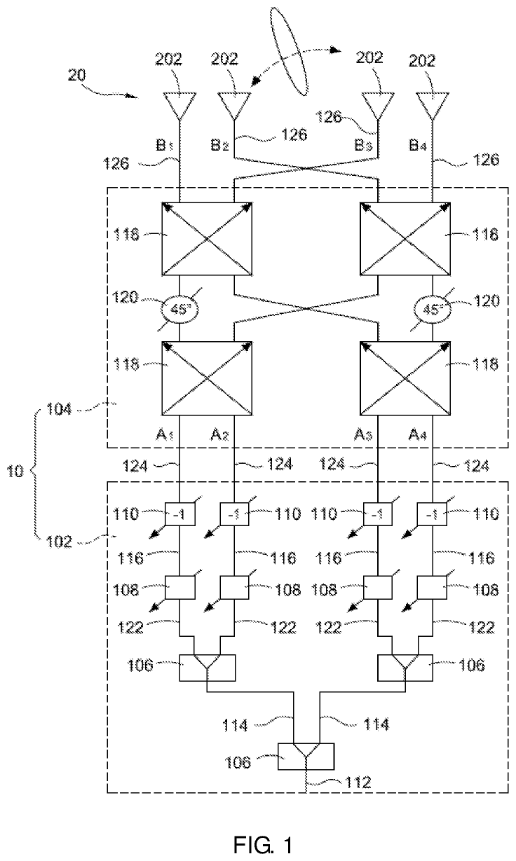

Pleace refer to FIG. 1, which is a functional block diagram of a single beam steering system according to an embodiment of the invention. A single beam steering system 10 is applied to an antenna matrix unit 20. The antenna matrix unit 20 comprises a plurality of antenna subunits 202. The single beam steering system 10 comprises a fine-beam tuner 102 and a phased array unit 104. The fine-beam tuner 102 comprises at least one power dividers/combiners 106, a plurality of level controller 108 and a pluraility of switchable inverter 110. The phased array unit 104 comprises a plurality of 3 dB quadrature hybrid couplers 118, a plurality of 45° phase shifters 120, a plurality of input terminals A₁-A₄, and a plurality of input terminals B₁-B₄. The components above are electrically connected to each other, and the phased array unit 104 may be a Butler matrix but is not limited thereto.

When the single beam steering system 10 is in a transmitting state, a first signal 112 is transmitted to at least one power dividers/combiners 106. The at least one power dividers/combiners 106 is used to divide the first signal 112 into a plurality of second signals 114 with equal power. In FIG. 1, three power dividers/combiners 106 are included, so the second signals 114 are transmitted to the other two power dividers/combiners 106 respectively to divide the second signals 114 into a plurality of second subsignals 122 with equal power.

The second subsignals 122 are transmitted to the level controllers 108 respectively. The level controllers 108 are adjustable attenuators, adjustable amplifiers, or a combination of the adjustable attenuators and the adjustable amplifiers. Based on a requirement to generate a specific phase difference between a plurality of phase array signals 126, the second subsignals 122 are attenuated or amplified to generate a plurality of third signals 116.

The third signals 116 are transmitted to the switchable inverters 110 respectively. Based on a requirement to generate a specific phase difference between the plurality of phase array signals 126, the switchable inverters 110 are used to control and switch the third signals 116 and a plurality of fourth signals 124 in phase (phase difference is 0°) or inverted phase 0 (phase difference is 180°). The switchable inverters 110 transmit the fourth signals 124 to the phased array unit 104. That is, based on the requirement to generate a specific phase difference between the plurality of phase array signals 126, the switchable inverter 110 receives the third signals 116 and does not invert the phase of the third signals 116 (that is, in phase, phase difference is 0°) to obtain the fourth signals 124, or the switchable inverter 110 receives the third signals 116 and inverts the phase of the third signals 116 (the phase difference is 180°) to obtain the fourth signals 124.

The 3 dB quadrature hybrid coupler 118 and the 45° phase shifter 120 of the phased array unit 104 process the fourth signals 124 to generate a plurality of phase array signals 126. The phased array unit 104 transmits the phase array signals 126 to the antenna subunits 202 to wirelessly send the phase array signals 126 in a single beam.

That is, the fine-beam tuner 102 is used to control the phase differences between the phase array signals 126 of the phased array unit 104 to form a single beam. Based on a requirement to generate a specific phase difference between the plurality of phase array signals 126, the level controller 108 decides to attenuate or amplify the second subsignals 122, and the switchable inverter 110 decides to invert or not invert the phase of the third signals 116.

The description of the single beam steering system 10 in the receiving state is similar to the description of the single beam steering system 10 in the transmitting state but in opposite direction, so the description of the single beam steering system 10 in the receiving state is omitted here. The power dividers/combiners 106 are used to combine the second subsignals 122 into the second signal 114, and combine the second signals 114 into the first signal 112.

Pleace refer to FIG. 1, the structure of the conventional 4×4 Butler matrix is like the phased array unit 104 in FIG. 1. The input signals at any one of the input terminals A₁-A₄ will output signals at the output terminals B₁-B₄ with an equal phase difference. The output signals are transmitted through the antenna matrix unit 20 to form a beam in a fixed direction. The beam direction is as listed in Table 1 below.

TABLE 1

| | Input signal | | | | | | | | |
|---|---|---|---|---|---|---|---|---|---|
| | size at each | | | | Phase difference between the output signals at | | | | |
| Input | input terminal | | | | each output terminal and the input signals | | | | Beam |
| terminals | A₁ | A₂ | A₃ | A₄ | B₁ | B₂ | B₃ | B₄ | angle |
| A₁ | 1 | 0 | 0 | 0 | e\hat{ }(−jπ/4) | e\hat{ }(−jπ/2) | e\hat{ }(−j3π/4) | e\hat{ }(−jπ) | 14.5° |
| A₂ | 0 | 1 | 0 | 0 | e\hat{ }(−j3π/4) | e\hat{ }(−j0) | e\hat{ }(−j5π/4) | e\hat{ }(−jπ/2) | −48.6° |
| A₃ | 0 | 0 | 1 | 0 | e\hat{ }(−jπ/2) | e\hat{ }(−j5π/4) | e\hat{ }(−j0) | e\hat{ }(−j3π/4) | 48.6° |
| A₄ | 0 | 0 | 0 | 1 | e\hat{ }(−jπ) | e\hat{ }(−j3π/4) | e\hat{ }(−jπ/2) | e\hat{ }(−jπ/4) | −14.5° |

Therefore, if the signals of the input terminals A₁-A₄ are switched, the direction of the beam can be switched. The conventional 4×4 Butler matrix has the advantages of simple structure but has the disadvantages of too few beams and fixed angles. If increasing the number of inputs and outputs of the conventional Butler matrix, more beam directions can be switched. However, the complexity of the circuit will be increased, and the function of continuous beam steering is still failed to be achieved. Therefore, some prior arts use adjustable phase shifters or active components to improve the lack or deficiency of the conventional Butler matrix. However, these methods will complicate the component structure and control circuit, resulting in higher production costs, and loss of the advantages of the simple structure of the conventional Butler matrix.

This disclosure is discussing how to control the input signals of the conventional Butler matrix to obtain the needed signal phase difference at the output terminals of the conventional Butler matrix. The relationship between the input signals and the output signals of the conventional Butler matrix can be expressed by the following Equation 1:

$$[ \begin{matrix}{B}_{1} \\ {B}_{2} \\ {B}_{3} \\ {B}_{4}\end{matrix} ] = {c}_{B} M [ \begin{matrix}{A}_{1} \\ {A}_{2} \\ {A}_{3} \\ {A}_{4}\end{matrix} ] \qquad ( Equation 1 )$$

c_{B} is a constant, which indicates the transmission loss of the signals in the Butler matrix. The transmission losses are assumed to be the same for each path and thus is considered as a constant. M in Equation 1 is a phase difference matrix from Aₙ to Bₙ, and M can be expressed as the following Equation 2:

$$M = [ \begin{matrix}{e}^{- j \frac{π}{4}} & {e}^{- j \frac{3 π}{4}} & {e}^{- j \frac{π}{2}} & {e}^{- j π} \\ {e}^{- j \frac{π}{2}} & {e}^{- j 0} & {e}^{- j \frac{5 π}{4}} & {e}^{- j \frac{3 π}{4}} \\ {e}^{- j \frac{3 π}{4}} & {e}^{- j \frac{5 π}{4}} & {e}^{- j 0} & {e}^{- j \frac{π}{2}} \\ {e}^{- j π} & {e}^{- j \frac{π}{2}} & {e}^{- j \frac{3 π}{4}} & {e}^{- j \frac{π}{4}}\end{matrix} ] \qquad ( Equation 2 )$$

If the phase difference between the output terminals is set to be φ, B can be expressed as the following Equation 3:

$$[ \begin{matrix}{B}_{1} \\ {B}_{2} \\ {B}_{3} \\ {B}_{4}\end{matrix} ] = [ \begin{matrix}1 \\ {e}^{- j ϕ} \\ {e}^{- j 2 ϕ} \\ {e}^{- j 3 ϕ}\end{matrix} ] \qquad ( Equation 3 )$$

From Equation 1, A is given by Equation 4 below:

$$[ \begin{matrix}{A}_{1} \\ {A}_{2} \\ {A}_{3} \\ {A}_{4}\end{matrix} ] = \frac{1}{{C}_{B}} {M}^{- 1} [ \begin{matrix}{B}_{1} \\ {B}_{2} \\ {B}_{3} \\ {B}_{4}\end{matrix} ] = \frac{1}{4 {C}_{B}} [ \begin{matrix}{e}^{j \frac{π}{4}} & {e}^{j \frac{π}{2}} & {e}^{j \frac{3 π}{4}} & {e}^{j π} \\ {e}^{j \frac{3 π}{4}} & {e}^{j 0} & {e}^{j \frac{5 π}{4}} & {e}^{j \frac{π}{2}} \\ {e}^{j \frac{π}{2}} & {e}^{j \frac{5 π}{4}} & {e}^{j 0} & {e}^{j \frac{3 π}{4}} \\ {e}^{j π} & {e}^{j \frac{3 π}{4}} & {e}^{j \frac{π}{2}} & {e}^{j \frac{π}{4}}\end{matrix} ] \cdot [ \begin{matrix}1 \\ {e}^{- j φ} \\ {e}^{- 2 φ} \\ {e}^{- 3 φ}\end{matrix} ] \qquad ( Equation 4 )$$

M⁻¹ is the inverse matrix of M. By solving the above Equation 4, A₁-A₄ can be obtained as the following Equations 5-8:

$$\begin{matrix}{A}_{1} = {r}_{1} {e}^{j {θ}_{1}} = {a}_{1} + j {b}_{1} = \frac{1}{4 {c}_{B}} [ ( \frac{\sqrt{2}}{2} + sin φ - \frac{\sqrt{2}}{2} cos 2 φ + \frac{\sqrt{2}}{2} sin 2 φ - cos 3 φ ) + \\ j ( \frac{\sqrt{2}}{2} + cos φ + \frac{\sqrt{2}}{2} cos 2 φ + \frac{\sqrt{2}}{2} sin 2 φ + sin 3 φ ) ] & ( Equation 5 ) \\ {A}_{2} = {r}_{2} {e}^{j {θ}_{2}} = {a}_{2} + j {b}_{2} = \frac{1}{4 {c}_{B}} [ ( - \frac{\sqrt{2}}{2} + cos φ - \frac{\sqrt{2}}{2} cos 2 φ - \frac{\sqrt{2}}{2} sin 2 φ + sin 3 φ ) + \\ j ( \frac{\sqrt{2}}{2} - sin φ - \frac{\sqrt{2}}{2} cos 2 φ + \frac{\sqrt{2}}{2} sin 2 φ + cos 3 φ ) ] & ( Equation 6 ) \\ {A}_{3} = {r}_{3} {e}^{j {θ}_{3}} = {a}_{3} + j {b}_{3} = \frac{1}{4 {c}_{B}} [ ( - \frac{\sqrt{2}}{2} cos φ - \frac{\sqrt{2}}{2} sin φ + cos 2 φ - \frac{\sqrt{2}}{2} cos 3 φ + \\ \frac{\sqrt{2}}{2} sin 3 φ ) + j ( 1 - \frac{\sqrt{2}}{2} cos φ + \frac{\sqrt{2}}{2} sin φ - sin 2 φ + \frac{\sqrt{2}}{2} cos 3 φ + \frac{\sqrt{2}}{2} sin 3 φ ) ] & ( Equation 7 ) \\ {A}_{4} = {r}_{4} {e}^{j {θ}_{4}} = {a}_{4} + j {b}_{4} = \frac{1}{4 {c}_{B}} [ ( - 1 - \frac{\sqrt{2}}{2} cos φ + \frac{\sqrt{2}}{2} sin φ + sin 2 φ + \frac{\sqrt{2}}{2} cos 3 φ + \\ \frac{\sqrt{2}}{2} sin 3 φ ) + j ( \frac{\sqrt{2}}{2} cos φ + \frac{\sqrt{2}}{2} sin φ + cos 2 φ + \frac{\sqrt{2}}{2} c o s 3 ϕ - \frac{\sqrt{2}}{2} sin 3 φ ) ] & ( Equation 8 )\end{matrix}$$

From the above Equations 5-8, the magnitudes of A₁-A₄ can be derived as the following Equations 9-12:

$$\begin{matrix}{r}_{1} = \frac{1}{4 {c}_{B}} ( 4 + 3 \sqrt{2} ( sin φ + cos φ ) + {4 sin 2 φ + \sqrt{2} ( sin 3 φ - cos 3 φ ) )}^{1 / 2} & ( Equation 9 ) \\ {r}_{2} = \frac{1}{4 {c}_{B}} ( 4 - 3 \sqrt{2} ( sin φ + cos φ ) + {4 sin 2 φ + \sqrt{2} ( sin 3 φ - cos 3 φ ) )}^{1 / 2} & ( Equation 10 ) \\ {r}_{3} = \frac{1}{4 {c}_{B}} ( 4 + 3 \sqrt{2} ( sin φ + cos φ ) + {4 sin 2 φ + \sqrt{2} ( sin 3 φ - cos 3 φ ) )}^{1 / 2} & ( Equation 11 ) \\ {r}_{4} = \frac{1}{4 {c}_{B}} ( 4 + 3 \sqrt{2} ( sin φ + cos φ ) + {4 sin 2 φ + \sqrt{2} ( sin 3 φ - cos 3 φ ) )}^{1 / 2} & ( Equation 12 )\end{matrix}$$

The phase [−180°, 180°] of A₁-A₄ can also be derived from the above Equation 5-8 and using the following a tan 2 function:

$${θ}_{i} = atan 2 ( {b}_{i} , {a}_{i} ) = \{ \begin{matrix}arc tan ( \frac{{b}_{i}}{{a}_{i}} ) , if a > 0 , \\ arc tan ( \frac{{b}_{i}}{{a}_{i}} ) + π , if a < 0 and b \geq 0 , \\ arc tan ( \frac{{b}_{i}}{{a}_{i}} ) - π , if a < 0 and b < 0 ,\end{matrix} \qquad ( Equation 13 )$$

However, the complicated phase equations of A₁-A₄ are not listed here, because the phase relationship of A₁-A₄ is more important in the invention. Taking the relationship between θ₁ and θ₂ as an example, the ratio can be compared, that is, the ratio of b₁/a₁ and b₂/a₂. According to the above Equations 5 and 6, after arduous derivation, Equation 14 can be obtained:

$$\frac{{b}_{1} \cdot {a}_{2}}{{b}_{2} \cdot {a}_{1}} = 1 \qquad ( Equation 14 )$$

This result shows that θ₁ and θ₂ are either in phase or invert phase, according to the sign of aᵢ and bᵢ in Equation 13. Therefore, the phases of A₁-A₄ are not independent, and their relationship is either in phase or invert phase. Therefore, the invention uses simple inverters (ie, the switchable inverters 110) to control the required phases without the need for more complex adjustable phase shifter for fine tuning phase control. Regarding the sizes of A₁-A₄ calculated by the above Equation 4, the invention uses the level controllers 108 to regulate. That is, the level controllers 108 and the switchable inverters 110 of the invention respectively adjust the size and phase of each input signal according to the calculation result of Equation 4 to control the output signals of the Butler matrix to the set phase difference.

A 4 GHz 4×4 Butler matrix continuous beam steering system is taken as an example, and the set beam directions are 0°, 10°, and −30°. According to the calculation of Equation 4, the settings of the level controllers 108 and the switchable inverters 110 are listed in Table 2 below:

TABLE 2

| | | | | | Phase control | | | |
|---|---|---|---|---|---|---|---|---|
| Beam | Level control (dB) | | | | Inverter | Inverter | Inverter | Inverter |
| angle | LCU₁ | LCU₂ | LCU₃ | LCU₄ | 1 | 2 | 3 | 4 |
| 0° | −4 | −11.5 | −11.5 | −4 | 1 | 1 | 1 | 1 |
| −30° | −11.5 | −4 | −11.5 | −4 | 1 | 1 | 1 | −1 |
| 10° | −0.5 | −19 | −17 | −15 | 1 | 1 | 1 | 1 |

The LCU in the above Table 2 indicates a level controller, Inverter indicates a switchable inverter, “1” indicates that no inversion processing is performed, and “4” indicates that inversion processing is performed.

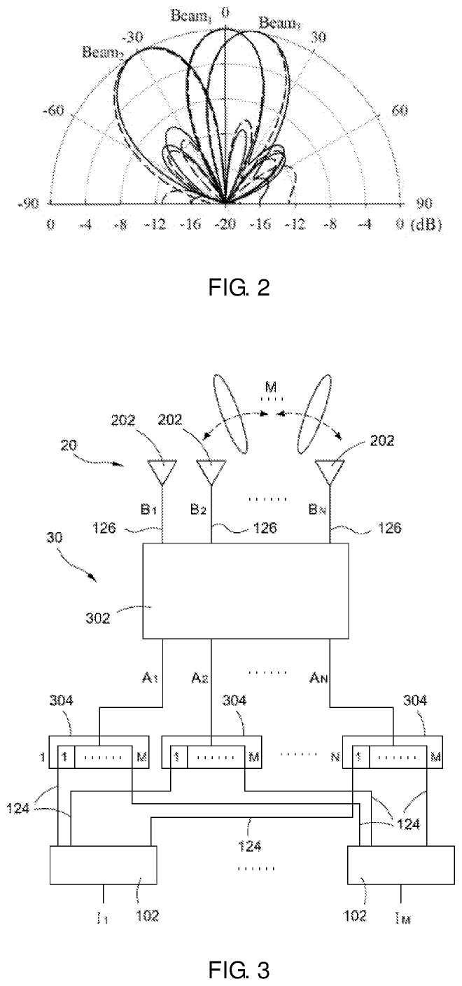

Pleace refer to FIG. 2, which is a diagram of a beam field pattern simulation and actual measurement results according to an embodiment of the invention (a single beam steering system). The dashed line indicates the simulation reslut, and the solid line indicates the actual measurement result. Beam₁ is the first beam. Beam₂ is the second beam. Beam₃ is the third beam. It can be seen from FIG. 2 that the simulated beam pattern is quite close to the actual measurement result. Therefore, the correctness of the single beam steering system of the invention can be confirmed.

Pleace refer to FIG. 3, which is a functional block diagram of a multi-beam steering system according to another embodiment of the invention. In FIG. 3, the description of the components being the same as those shown in FIG. 1 is not repeated here for simplicity. A multi-beam steering system 30 may be applied to an antenna matrix unit 20. The antenna matrix unit 20 comprises N antenna subunits 202. N is an integer greater than 1. The multi-beam steering system 30 comprises a N×N phased array unit 302, a plurality of M-channel power dividers/combiners 304 and a plurality of the fine-beam tuners 102. M is an integer greater than 1. The components are electrically connected to each other, and the N×N phased array unit 302 may be a N×N Butler matrix but is not limited thereto. The N×N phased array unit 302 comprises a plurality of input terminals A₁-A_{N} and a plurality of input terminals B₁-B_{N}.

The N×N phased array unit 302 (N in and N out) in FIG. 3 is similar to the phased array unit 104 (4 in and 4 out) in FIG. 1. The M-channel power dividers/combiners 304 in FIG. 3 are used to divide or combine signals. The fine-beam tuner 102 in FIG. 3 is similar to the fine-beam tuner 102 in FIG. 1, and therefore the description is not repeated here. The fourth signals 124 in FIG. 3 are transmitted to the N×N phased array unit 302 through the M-channel power dividers/combiners 304. The fine-beam tuner 102 are used to control the phase difference between a plurality of phase array signals 126 of the N×N phased array unit 302 to form multiple beams. The the N×N phase array unit 302 and the antenna matrix unit 20 are commonly used by the fine-beam tuner 102 and the M-channel power dividers/combiners 304. Hence, the complexity and manufacturing cost of the multi-beam steering system 30 can be greatly reduced.

With these M-channel power dividers/combiners 304, M single-beam steering systems can be constructed into a multi-beam steering system with M beam directions, and architecture of the multi-beam steering system is shown in FIG. 3. Taking the transmitting state as an example, the architecture of FIG. 3 is composed of M input signals I₁-I_{M} and M1×N fine-beam tuners 102 to control the size and phase of the N output signals. The output signals of each fine-beam tuner 102 via N M-channel power dividers/combiners 304 to output to the N×N phase array unit 302 (the N×N Butler matrix). Therefore, the output signals of the N×N phase array unit 302 include M sets of N signals with a fixed phase difference, so that M beams can be formed at the same time. The structure of FIG. 3 is also used as a receiver. At this time, the M-channel power dividers/combiners 304 function as a power combiner. Moreover, the N does not have to be equal to M (that is, N may be equal to M, or N may not be equal to M).

A multi-beam steering system with a 4 GHz 4×4 Butler matrix and two input signals (M=2) is taken as an example. The two beam directions are set to 18° and −18°, and their related parameter settings are shown in Table 3 below:

TABLE 3

| | | | | | | Phase control | | | |
|---|---|---|---|---|---|---|---|---|---|
| Signal | Beam | Level control (dB) | | | | Inverter | Inverter | Inverter | Inverter |
| input | angle | LCU₁ | LCU₂ | LCU₃ | LCU₄ | 1 | 2 | 3 | 4 |
| 1 | −18 | −18.5 | −17 | −20.75 | −0.25 | 1 | 1 | 1 | −1 |
| 2 | 18 | −0.25 | −20.75 | −17 | −18.5 | −1 | 1 | 1 | 1 |

The LCU in Table 3 above is expressed as a level controller. Inverter expressed as a switchable inverter. “1” indicates that no inversion processing is performed, and “4” indicates that inversion processing is performed.

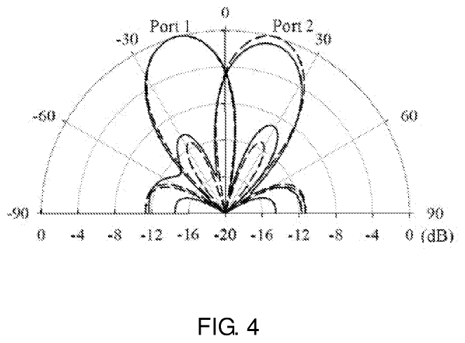

Pleace refer to FIG. 4, which is a diagram of a beam field pattern simulation and actual measurement results according to another embodiment of the invention (a multi-beam steering system). The dashed line indicates the simulation, and the solid line indicates the actual measurement result. Port1 indicates the field type caused by the first input terminal, and Port2 indicates the field type caused by the second input terminal. It can be seen from FIG. 4 that the simulation and actual measurement results are quite close, so the correctness of the multi-beam steering system of the invention can be confirmed.

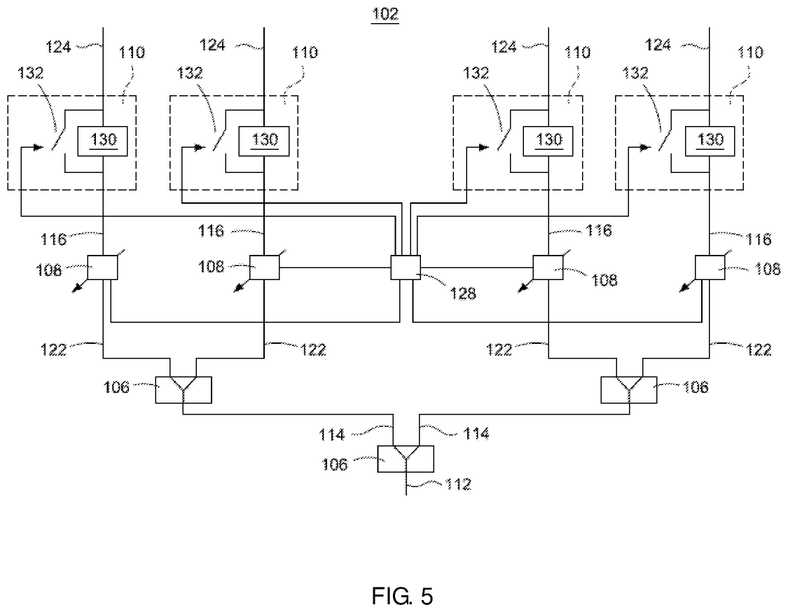

Pleace refer to FIG. 5, which is a functional block diagram of a fine-beam tuner according to another embodiment of the invention. The components shown in FIG. 5 are the same as those shown in FIG. 1, so the description thereof is not repeated here for simplicity. Furthermore, the fine-beam tuner 102 further includes a microcontroller 128. The microcontroller 128 is electrically connected to the level controllers 108 and the switchable inverters 110. Based on the requirement to generate a specific phase difference between the aforementioned phase array signals 126 (as shown in FIG. 1 or FIG. 3). The microcontroller 128 is used to control the level controllers 108 to attenuate or amplify the second subsignals 122 to generate the third signals 116 and control the switchable inverters 110 to invert or not invert the phase of the third signal 116 to obtain the fourth signal 124.

In addition, each of the switchable inverter 110 may include an inverter 130 and a bypass 132. The inverter 130 is electrically connected to one of the level controllers 108. The bypass 132 is electrically connected to the microcontroller 128 and one of the level controllers 108. When the microcontroller 128 controls the switchable inverter 110 not to invert the third signal 116, the microcontroller 128 turns on the bypass 132 so that the third signal 116 passes through the bypass 132 to becomes the fourth signal 124. When the microcontroller 128 controls the switchable inverter 110 to invert the third signal 116, the microcontroller 128 does not turn on the bypass 132, so that the inverter 130 inverts the phase of the third signal 116 to obtain the fourth signal 124.

In summary, the invention uses the fine-beam tuner 102 to control the size and phase of the input signal of a phase array (such as a Butler matrix) to regulate the phase difference of the signals at the output end of the phase array, so as to achieve a synthetic beam system for continuous beam steering. The fine-beam tuner 102 comprises the at least one power dividers/combiners 106, the level controllers 108, and the switchable inverters 110. Based on transmission or reception, the at least one power dividers/combiners 106 can divide the input signal into multiple output signals with equal power, or combine multiple input signals into one output signal. Based on the algorithm, the level controllers 108 and the switchable inverters 110 respectively adjust the size and phase of the input signals of the phase array to control the output signals of the phase array to have a set phase difference. Furthermore, based on the sharing of an N×N phased array unit 302 and an antenna matrix unit 20, a multi-beam steering system can also be constructed using the fine-beam tuner 102 and the M-channel power dividers/combiners 304. The invention does not use an adjustable phase shifter or an active phase shifter to control the phase of the signal. Therefore, the invention is easy to implement and has a low cost to implement a beam forming system capable of continuous beam steering.

Accordingly, based on the phase array, the simple structure, and low cost, continuous beam steering and a beam forming system with multi-beam can be realized.

However, the above are only preferred embodiments of the invention, and the scope of implementation of the invention cannot be limited. That is, all equal changes and modifications made in accordance with the scope of the patent application of the invention should still fall within the scope of the patent scope of the invention. The invention may have various other embodiments, without departing from the spirit and essence of the invention, those skilled in the art can make various corresponding changes and modifications according to the invention. But these corresponding changes and modifications should all fall within the protection scope of the patent application scope attached to the invention. In summary, the invention is known to have Industrially Applicable, Novelty, and Non-Obviousness. Moreover, the structure of the invention has not been seen in similar products and used in public, and fully complies with the requirements for the application for an invention patent, and is filed in accordance with the Patent Law.

What is claimed is:

1. A single beam steering system applied to an antenna matrix unit comprising a plurality of antenna subunits, the single beam steering system comprising:
a fine-beam tuner used to control phase differences between a plurality of phased array signals of the phased array unit, wherein the fine-beam tuner comprises:
at least one power divider/combiner;
a plurality of level controllers electrically connected to the at least one power divider/combiner; and
a plurality of switchable inverters electrically connected to the plurality of the level controllers and the phased array unit; and
a phased array unit electrically connected to the fine-beam tuner and the antenna subunits, wherein phase differences among a plurality of phased array signals of the phased array unit are controlled by the fine-beam tuner.

2. The single beam steering system of claim 1, wherein the phased array unit is a Butler Matrix.

3. The single beam steering system of claim 1, wherein the at least one power divider/combiner is used to divide a first signal into a plurality of second signals with equal power, or combine the plurality of the second signals into the first signal.

4. The single beam steering system of claim 3, wherein the level controllers are adjustable attenuators or adjustable amplifiers, or a combination of the adjustable attenuators and the adjustable amplifiers.

5. The single beam steering system of claim 4, wherein the switchable inverters are used to control and switch whether a third signal and a fourth signal to be in phase or out of phase.

6. A multi-beam steering system applied to an antenna matrix unit comprising N antenna subunits, the multi-beam steering system comprising:
a N×N phased array unit electrically connected to the N antenna subunits, wherein the N is an integer greater than 1;
a plurality of M-channel power dividers/combiners electrically connected to the N×N phased array unit, wherein the M is an integer greater than 1; and
a plurality of fine-beam tuners electrically connected to the M-channel power dividers/combiners to control phase differences between a plurality of phased array signals of the N×N phased array unit, wherein each of the fine-beam tuners comprises:
at least one power divider/combiner;
a plurality of level controllers electrically connected to the at least one power divider/combiner; and
a plurality of switchable inverters electrically connected to the level controllers and the M-channel power dividers/combiners.

7. The multi-beam steering system of claim 6, wherein the N×N phased array uni is a N×N Butler Matrix.

8. The multi-beam steering system of claim 6, wherein the at least one power divider/combiner is used to divide a first signal into a plurality of second signals with equal power, or combine the plurality of the second signals into the first signal.

9. The multi-beam steering system of claim 8, wherein the level controllers are adjustable attenuators or adjustable amplifiers, or a combination of the adjustable attenuator and the adjustable amplifiers.

10. The multi-beam steering system of claim 9, wherein the switchable inverters are used to control and switch whether a third signal and a fourth signal to be in phase or out of phase.
